(19) United States
(12) Patent Application Publication
(10) Pub. No.: US 2022/0067301 A1
(43) Pub. Date: Mar. 3, 2022

(54) Conversational flow apparatus and technique

(71) Applicant: Arm Cloud Technology, Inc., San Jose, CA (US)

(72) Inventors: Remy POTTIER, Grenoble (FR); Charles Gérard Jacques VATIN, Nice (FR); Benjamin Jousseaume DE LA BRETESCHE, Nice (FR)

(21) Appl. No.: 17/445,668

(22) Filed: Aug. 23, 2021

(30) Foreign Application Priority Data
Aug. 27, 2020 (GB) 2013480.5

(51) Int. Cl. G06F 40/35; G06F 40/289; G06N 5/02

(52) U.S. Cl. CPC G06F 40/35; G06N 5/022; G06F 40/289

(57) ABSTRACT

Provided is a technology including an apparatus in the form of an adaptive conversational flow engine for operating comprising a machine-learning model comprising at least one sequence of states of a conversational flow; an anomaly detector operable to monitor said at least one sequence of states in operation; data capture logic operable in response to said anomaly detector to capture data linked to a detected anomaly at an anomaly-detected state of said at least one sequence of states in operation; annotator logic operable in response to said data capture logic to link a tag with at least said data to said anomaly-detected state to create a tagged state; and refinement logic to refine said machine-learning model according to inputs obtained using said tagged state.

### CROSS-REFERENCE TO RELATED APPLICATIONS

This application claims priority pursuant to 35 U.S.C. 119(a) to United Kingdom Patent Application No. 2013480.5, filed Aug. 27, 2020, which application is incorporated herein by reference in its entirety.

### BACKGROUND

The present technology is directed to an apparatus and technique to support effective conversational flows to applications in computer systems. The conversational flow engine may be provided in the form of dedicated hardware or in the form of firmware or software at a low level in the system stack (or of a combination of hardware and low-level code), to provide application-level programs with conversational flow capabilities.

Conversational flow engines typically take the form of artificial intelligence reasoning systems that have three operational phases: communication perception, decision and action. The communication perception phase involves analysing inputs with reference to the current conversational state to extract usable meaning that can be used as the basis for reasoning. The decision phase may use any of the tools available in the field of artificial intelligence—rule trees, knowledge bases, case-based reasoning and the like. The workings of the decision phase are typically probabilistic, so that outputs are weighted using probabilities derived by analysis from substantial datasets of knowledge representations. Again, typically, conversational flow engines must be made adaptive, so that the machine learning (ML) process can continually contribute to refining the accuracy of outcomes. The action phase is the result of the application of these decision-making techniques to the inputs from the communication perception phase, and may comprise a conclusive response, or a script or menu of further proposed interactions to enable further iterations to home in on a conclusive outcome.

Conversational flow engines may provide the supporting environment for voice assistant applications, chatbots, machine-to-machine training systems in robotics, interactive user interfaces, and the like, and may typically take the form of specialised hardware core libraries or firmware libraries.

To take the chatbot as an example, a chatbot is an application that interacts in a format similar to an instant messaging conversation. They can answer questions formulated to them in natural language and respond like a real person. They provide responses typically based on a combination of predefined scripts and machine learning applications. When asked a question, a chatbot will respond based on the knowledge database available to it at that point in time. If the conversation introduces a concept it is not programmed to understand, it will typically either deflect the conversation or potentially pass the communication to a human operator. Whichever of these it does, it will also learn from that interaction as well as from subsequent interactions. By artificially replicating the patterns of human interactions in machine learning, chatbots allow computers to learn by themselves without inputs from a human operator. Thus, the chatbot will gradually grow in scope and gain in relevance and accuracy of response. A chatbot is like a normal application with an application program layer, a database and APIs to call external administrative functions, such as supporting library functions. Chatbots typically utilize pattern matching to enable them to analyze inputs using Natural Language Understanding (NLU) and Natural Language Processing (NLP) and to render the inputs into a form in which some kind of reasoning can be applied to produce an appropriate response. Conventionally, chatbots are trained according to the past information available to them. So, most implementations maintain logs of interactions that can be used by developers to analyze what the human participant is trying to ask and to provide the chatbot with the means to provide with the most appropriate answers when the same pattern is encountered in a subsequent interaction.

As described above, flows of interactions may be retained in storage (for example, as stream datasets) and modelled (for example, as decision trees or graphs) for reference purposes and to provide insights for the further refinement of the machine learning model. It is in these forms that, conventionally, human analysts examine the data looking for instances of failures and sub-optimal outcomes, with a view to refining the model for future use. Failures in conversational flows may take the form of ambiguities (where two or more meanings can be extracted from the same interaction with a participant, and it is unclear which of the meanings is correct), or failure to extract a meaning from an interaction caused by, for example, noise interference with perception of an utterance, deficiency in a natural language dictionary, miscomprehension by a participant leading to a response that is meaningless in context, and the like.

In one well-known analysis of the behaviour of machine learning systems, outright failures and other non-optimal outcomes are described as non-cooperative situations, and these may be classified according to the phase of the flow in which they occur. In the communication perception phase, there may be outright incomprehension or ambiguity; in the decision phase, there may be a total or partial lack of competence to make a decision, or there may be an unproductive decision (one that cannot reasonably be acted upon); in the action phase, there may be conflicting actions or actions that are useless in the real world.

In a much-simplified example of an anomaly (or non-cooperative situation) that has its origin in the communication perception phase, a dataset shows that the participant used the word “alter” in a sentence about flight bookings and was repeatedly misdirected to flight information about “Gibraltar” because the conversational flow vocabulary subset for the interaction did not allow for “alter” as a synonym for “change”. The model in this case needs to be retrained to accept “alter” as a synonym, or at least to add a verifying interaction to clarify that “alter” is meant, rather than a topic change to “Gibraltar”. In the tree or graph structure, the selection of a next step (that is, the decision phase) based on “alter”=“change” needs to have its probabilistic score or weighting increased over the scores of any “Gibraltar”-related nodes. Many other examples of failures or sub-optimal outcomes will be evident to one of skill in the art, where the conversational flow stalls, produces an unhelpful outcome, diverges from the user's intentions, or is otherwise unable to determine a correct next step because of a sudden change of apparent topic or an unresolved ambiguity in the conversational exchange. Other examples will be clear to one of ordinary skill in the field of human-computer and computer-computer interactions.

In a first approach to addressing failures and inefficiencies in human-computer and computer-computer conversational flows there is provided a technology including an apparatus in the form of an adaptive conversational flow engine for operating comprising a machine-learning model comprising at least one sequence of states of a conversational flow; an anomaly detector operable to monitor said at least one sequence of states in operation; data capture logic operable in response to said anomaly detector to capture data linked to a detected anomaly at an anomaly-detected state of said at least one sequence of states in operation; annotator logic operable in response to said data capture logic to link a tag with at least said data to said anomaly-detected state to create a tagged state; and refinement logic to refine said machine-learning model according to inputs obtained using said tagged state.

In a second approach there is provided a method of operating an adaptive conversational flow engine.

In a hardware implementation, there may be provided electronic apparatus comprising logic elements operable to implement the methods of the present technology. In another approach, the method may be realised in the form of a computer program operable to cause a computer system to enact conversational flows according to the present technology.

### BRIEF DESCRIPTION OF THE DRAWINGS

Implementations of the disclosed technology will now be described, by way of example only, with reference to the accompanying drawings, in which:

FIG. 1 shows simplified example of a conversational flow engine operable in communication with a participant according to an embodiment of the present technology that may comprise hardware, firmware, software or hybrid components; and

FIG. 2 shows one example of a method of operation of a conversational flow engine according to an instance of the present technology.

### DETAILED DESCRIPTION

The advent of computing devices and programs that serve the needs of users by offering conversational capabilities has massively expanded the means of communication available at the human-computer interface, but at the same time has brought opportunities for confusion, error and frustration. The ways in which computers and humans process and communicate information differ fundamentally, and the challenge to interface designers is always to find ways to bridge that gap. In addition, many computing devices now need to provide conversational capabilities with both human users and other computers at the same time. This is particularly the case with the expansion of the Internet of Things, where machines that are not primarily conventional computers have computing capabilities but need to interact with human users and other computers in simpler, more intuitive and less rigid ways, addressing at least some of the protocol clashes that frequently arise in human-computer and computer-computer flows.

Tagging (or annotating) data to prepare a dataset (especially a conversational flow dataset, such as a dataset representing a chatbot interaction) for supervised learning is today done manually by large numbers of human data analysts, and only then can the tagged dataset be used to retrain models using supervised learning techniques. Some tools exist to help humans to tag data, but the process remains human-input intensive, because of the need to analyse complex failures and anomalies causing sub-optimal outcomes in either natural or constrained language scenarios of significant complexity—the level of complexity is typically far greater than the “alter”—“Gibraltar” example described above, and may stem from many sources, both of linguistics and context.

The present technology provides dynamic annotation (tagging) of conversational flow data with context metadata in real time or using near real time back end systems, such as a customer data platform (CDP), to allow automated feedback looping to AI model learning or inference scenarios), e.g. in reinforcement learning, hybrid learning and other active learning). This adds a new level of intelligence above current automated machine learning (ML) tools and systems by creating new feedback loops that leverage the intelligent automation of data annotation. Automating the data tagging process of flow datasets or data, for example in chatbots or other voice assistant systems, enables closing of the loop in the learning process.

The tags or annotations may contain a variety of data, including:
Identification of the base data from user/service provider;
Clarification of past queries (for example, Query N−1, Query N−2 Answer N−1, Answer N−2);
Context clarifications:
   Time, day, country/language;
   Decision tree in use (in the case of a rule based chatbot);
   Digital data inputs (for example, extracts from a Customer Data Platform):
      User identity;
      User behaviour patterns derived from historical records;
      User past demand;
      User segment;
      Past interaction inputs;
      Weather data, or other digital environmental data;
   Physical data inputs (for example, from an IoT—Internet of Things—device input):
      IoT Device Capabilities;
      IoT device Action;
      IoT device Event log;
      IoT device Properties;
      Interaction pattern.

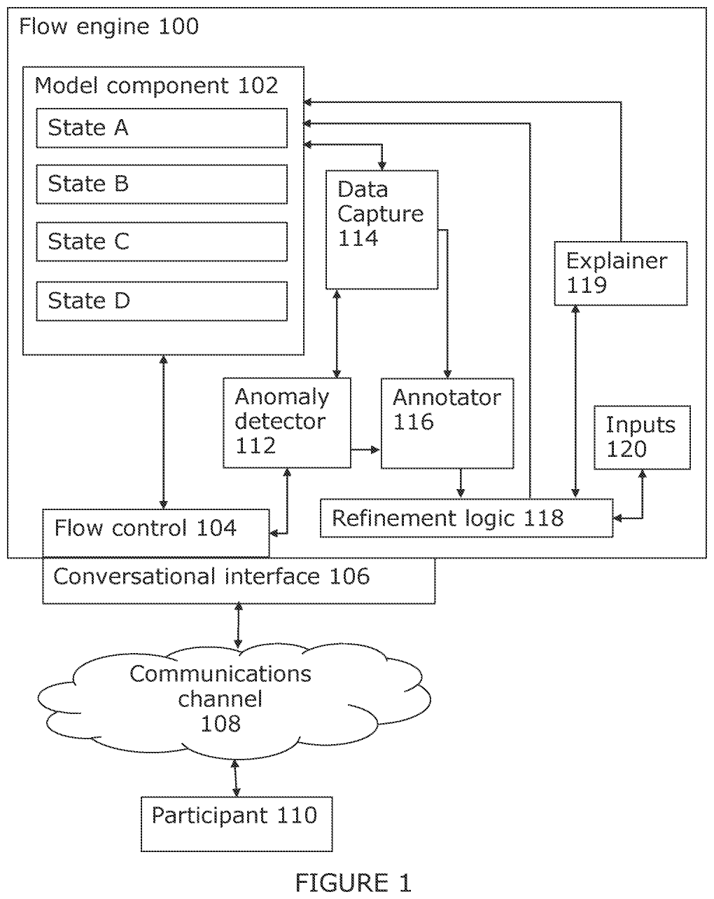

Turning to FIG. 1, there is shown a simplified example of a conversational flow engine 100 operable in communication with a participant 110 according to an embodiment of the present technology. In FIG. 1, flow engine 100 is operably connected through conversational interface 106 and communications channel 108 to participant 110. Participant 110 may be a human user or another device that is capable of communicating with flow engine 100 using a machine-to-machine (M2M) interface. In one example, participant 110 may be a robot that is capable of machine learning by interaction with flow engine 100. Flow engine 100 comprises a model component 102 that provides models of potential interactions, each such interaction comprising a sequence of states, as shown by State A, State B, etc. in the figure. The sequence of states, as will be known to one of skill in the art may comprise states of a neural network, states or nodes of a rule tree or graph, or nodes of any other knowledge representation technology. Reasoning over a sequence of states may take the form of dynamic reasoning using a Hidden Markov Model (for example, a Viterbi algorithm approach) or static reasoning using a Finite State Transducer approach.

In another example, for a speech recognition component, a neural network, such as a Long Term Short Term Memory neural network or a fully Recurrent Neural Network, may be used.

The tags accompanying the data may be used to train the model by reinforcement learning. Reinforcement learning focuses on learning from experience. In a typical reinforcement learning setting, an agent interacts with its environment, and is given a reward function that it tries to optimise, for example the system might be rewarded for solving the non-cooperative situation using the tag metadata from the examples above.

Model component 102 is operable in connection with explainer component 119 to record and provide explanations of its reasoning procedures as required, both for the user of the flow engine to understand how conclusions were reached, for diagnosis in the case of false reasoning, and for regulatory compliance as required in certain use cases and jurisdictions. The explainer component may only be operable in certain implementations—in other implementations, the reasoning may not be susceptible to straightforward procedural analysis.

In normal operation, flow engine 100 uses the states of model component 102 both to control the conversational flow by inputs to flow control 104 and to store the dataset comprising the sequence of states of a particular interaction. Flow control 104 receives inputs from model component 102 in the form of probabilistically-determined next steps in the conversation conducted over conversational interface 106. Flow control 104 also receives inputs from participant 110 over communications channel 108, and passes these in the conventional manner to model component 102 for analysis and determination of a best next step to be taken from the current state and its input data. The interactions with the participant are iterative, and may include, for example, indications that the conversational flow engine does not “understand” an input, requests for additional information or restatement in clearer terms, and the like. In one example, an indication that the conversational flow engine does not “understand” an input may be determined by detecting a low probability of a word or path in context.

In the flow engine 100 of the present technology, the conversational flow is monitored at flow control 104 by an anomaly detector 112 operable to detect anomalies in the flow or the individual states of the flow—these anomalies may comprise, for example, failure states or detected divergences of flow from a prior-established norm—these are sometimes known as “non-cooperative situations”. Anomalies can be of different types—for example, an ambiguity where an input may be susceptible to two (or more) different interpretations, or a complete or partial failure to extract an interpretation from an input. The effects of the anomaly may be detected in any of the phases of interpretation and processing of the conversational flow state: the communication perception phase, the decision phase, or the action phase.

The anomaly detector 112 may comprise introspective instrumentation within the flow control or model components, an independent sub-component of the flow engine or an external monitoring component. The anomaly detector may be sensitised to any number of indicators that the state is incorrect and that the current model is maladapted—for example, a user may start to incorporate emotive language in the conversation, there may be interference from environmental noise, and many other indicators. Responsive to an alert from anomaly detector 112, data capture component 114 is operable to capture data, particularly data from the model component that has a high probability of linkage to the anomaly; for example, the sequence of immediately preceding states with their potential outcomes, the probabilistic weightings relevant to the outcomes, the potential states going forward from the anomalous state and their probabilistic weightings. Anomaly detector 112 is further operable to analyse the type of anomaly—whether it is, for example, an ambiguity, where two (or more) possible interpretations are available, or whether it is a complete or partial failure to extract information from a response. Anomaly detector is further operable to localise the anomaly to its phase in the operation of the conversational flow engine—whether the anomaly affects the accuracy of the communication perception phase, the decision phase or the action phase of the process. In the course of this analysis, the anomaly detector 112 is operable to construct as comprehensive a picture of the a detected anomaly and its context as possible from the data available, including, but not limited to the anomalous interaction itself, preceding interaction data, environmental data (such as noise interference on a channel), the decision tree state, and probabilistic data relating to those potential future actions that were available at the time of detecting the anomaly. As would be clear to one of ordinary skill in the art, this data taken together builds a picture of the context of the anomalous state, and this is passed by data capture component 114 to annotator 116. Annotator 116 creates an annotation or tag that incorporates the captured data and attaches the tag to the state data for the anomalous state. Responsive to the finding of such a tag attached to a state, refinement logic 118 analyses the captured data and if necessary requests additional inputs 120 from any of a number of external sources, such as, for example, user profile databases, other reasoning engines with application to the captured data and the like. Refinement logic 118 is then operable in cooperation with model component 102 to adapt the model in accordance with insights gained from the captured data from data capture component 114 and the external inputs 120. Refinement logic 118 is further operable in cooperation with model component 102 to modify the explanatory data held by explainer component 119 according to the changes made by refinement logic 118.

The present technology thus automates the combination of neural network standard training with symbolic artificial intelligence: by annotating the dataset to be used for ML model training, the system can be made to reason using rules about how the world works in a similar way the human brain would do it (humans see a scene, not just a standalone object; humans understand scenarios—for example we can differentiate a bed in a hotel bedroom from a hospital bed). It is not, of course, possible to hard code all the scenarios in some kind of rule-based system, and so the present technology is operable to help automate the scenario creation. The dynamic and automated annotation of data with “intelligent metadata” offers a way to close the loop and force these rules into the model without human intervention, thus enabling (but not limited to) automated reinforcement learning of ML models.

The inputs elicited by the tagging may be derived by reasoning over the tagged state using, for example, predecessor state data leading up to the anomaly or a lack of competence to decide a correct successor state caused by ambiguity or noise. Inputs may also be obtained from an external source, such as a user data profile or history of the user's previous interactions.

In one refinement applicable to active learning (and also to self-learning robots), the model component itself is made introspective, by incorporating the anomaly detector, and is thus operable to identify a state that it has difficulty with and to request an annotation linked to that state, to shorten the gap between the anomaly discovery and the refinement of the model to address potential incorrect inferences.

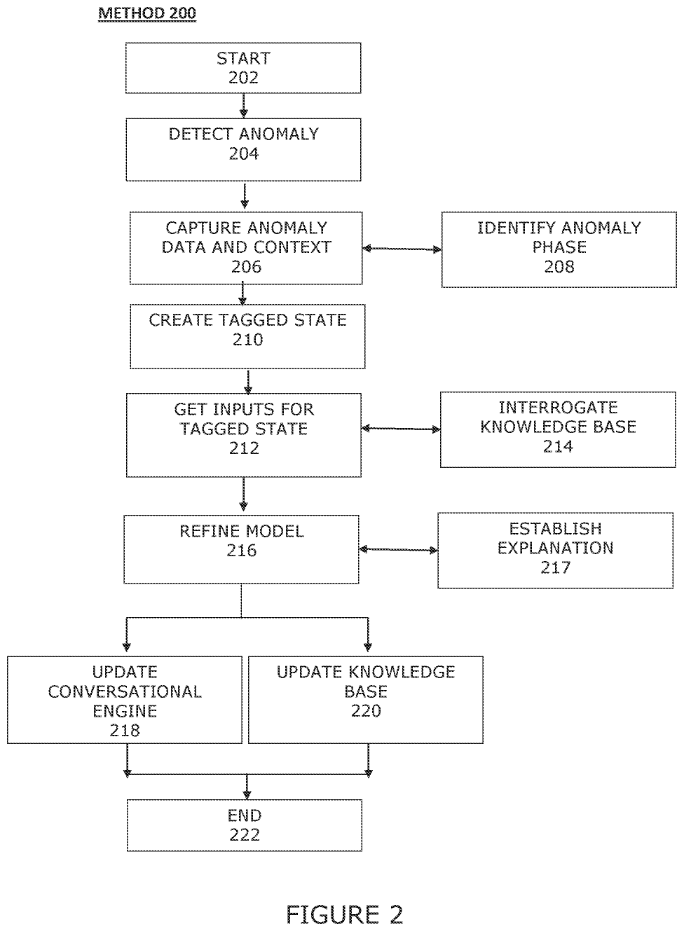

Turning now to FIG. 2, there is shown one example of a method 200 of operation of a conversational flow engine according to an instance of the present technology. The method 200 begins at START 202, when monitoring activity according to the present technology begins on a conversational flow engine as delineated in FIG. 1 above. At 204, an anomaly is detected, and at 206 the data and context of the anomaly (current, previous and potential successor states and the like, as described above) are captured. Additional input to localise the phase in the reasoning (communication perception, decision, action) affected by the anomaly is identified at 208 and used by capture step 206. The tagged state is created at 210, and at 212 external inputs are sought and received relating to the tagged state. One or more knowledge bases may be interrogated at 214 to provide the external inputs. At 216, the data, context and external inputs are used to refine the model, and introspective instrumentation may be used at 217 to establish an explanation of the data and reasoning that underlie the refinements of the model. At 218, the conversational flow engine is updated to take account of the refinements to the model, and all the activities from the detection of the anomaly at 204 through the process to the conversational engine update at 218 are used at 220 to update the knowledge base for future reference. The process completes at END 222, although it will be clear to one of skill in the art that the process between START 202 and END 222 is susceptible of iteration as required.

For fuller understanding, here are presented short summaries of some of the possible use cases for the present technology:
1. Voice: when voice recognition does not work correctly, the present technology can help to create context awareness and retrain the model for data it has the most difficulties with. The voice command data is made operable to carry an annotation that causes recovery of inputs that may be derived by reasoning or provided by other devices or systems. For example:
   a. Voice command tagged with real time context provided by the same microphone (e.g. background noise information, etc. . . . ) or by other sensors/IoT/mobile devices (e.g. vibration based sensors telling that washing machine is on, water tap is open, the user is doing x, y or z, the user's location—indoor/outdoor, in the supermarket, in the street, at work, . . . )
   b. Voice command is tagged with previous voice commands, for example the 2-3 previous voice commands stored in the device itself or in the system somewhere. This enables the system to provide input giving the context for the conversation, enabling the model to learn what should be a correct answer in a later, similar context.
2. Chatbots: when the chatbot does not work correctly, the present technology can help to create context awareness and retrain the model for data it has the most difficulties with. The chatbot data is made operable to carry an annotation that causes recovery of inputs that may be derived by reasoning or provided by other devices or systems. For example:
   a. To implement dialogues having verisimilitude (where the chatbot appears to be human) the present technology is operable to automatically add annotations to improve quality and reinforce model prediction (or the rule-based decision tree)—this is done manually today at considerable cost in resource. The present technology creates an automated feedback loop, using automated data tagging when system divergence is observed by the monitoring instrumentation.
   b. “User data” (e.g. the user's environmental context, profile, category, PII, and previous behavior) metadata, provided by a user data profile or customer relationship management system, for example, could be added to the chatbot dialog text entered by the user, enabling user-aware model re-training and new rule creation.
   c. The chatbot, when facing a difficulty, could dynamically tag problematic conversational data with the relevant rule tree, such that the rule tree could be adjusted to better represent the real-world interaction for future instances.

The intelligent monitoring instrumentation thus understands that the conversational flow (as embodied, for example, in a chatbot) has failed or is diverging from a preestablished norm, and then causes the automatic tagging or annotation of the conversational state data with metadata that represents the context and the re-injection of this annotation into the model to close the loop and re-train the model.

In a CDP (Customer Data Platform) environment, automated data tagging according to the present technology would enable context-aware recommendations to improve next best action models by adding physical and digital context on customer behavior during a previous marketing interaction with a conversational system. The present technology would thus allow a provider to base a recommendation on continuously automatically tagged campaign marketing information (content, style, channel, sociodemographic, etc.) instead of on the conventional Click-Through Rate (CTR).

The data tagging of the present technology would also enable different datasets to be tied together automatically (for example by a common identifier or common label or tag) at the point of input to the CDP platform, to enrich the individual datasets with context information and potentially to enable automatic new segmentation at the intersection of physical (“real-world”) and digital data. In this way, the present technology would assist not only in improvements to the conversational flow technology, but also to the offline data analytics. In one example, the technology in this application could enable different views of same dataset dynamically. Data in the dataset could be dynamically tagged with a “level” label, then different users with levels of access or service could dynamically access the same dataset with different views.

In active learning, instrumentation associated with the model would identify a data point that it has difficulty with and actively requests a label for it; in conventional supervised learning systems, a human analyst would intervene at this point and provide the tag. However, with the present technology, the tagging process is automated, and the model is thus able to shorten the time taken to relearn and correct various wrong inferences.

There is thus provided, in examples, an adaptive conversational flow engine comprising a machine-learning model comprising at least one sequence of states of a conversational flow; an anomaly detector operable to monitor the at least one sequence of states in operation; data capture logic operable in response to the anomaly detector to capture data linked to a detected anomaly at an anomaly-detected state of the at least one sequence of states in operation; annotator logic operable in response to the data capture logic to link a tag with at least the data to the anomaly-detected state to create a tagged state; and refinement logic to refine the machine-learning model according to inputs obtained using the tagged state. The adaptive conversational flow engine may be operable to support natural-language interaction.

The adaptive conversational flow engine may have an anomaly detector that is operable to detect at least one of an ambiguity in an interaction, a failure to extract meaning from a response, a divergence in conversational flow topic, a missing response, an indicator of noise interference, an indicator of emotive response and an indicator of a misunderstood question-response interaction. The adaptive conversational flow engine may have an anomaly detector further operable to localise an effect of the anomaly-detected state to a phase in the operation of the conversational flow engine. The data capture logic may further be operable to capture data linked to at least one predecessor state of the anomaly-detected state or to at least one potential successor state of the anomaly-detected state. The refinement logic may be operable to retrain the machine-learning model. The inputs obtained using the tagged state may comprise a noise adjustment algorithm output, previously-stored data associated with a user of the adaptive conversational flow engine or outputs of machine reasoning over the data linked to the detected anomaly. The adaptive conversational flow engine may further comprise a knowledge base provisioned with data derived from at least one prior instance of handling an anomaly. The adaptive conversational flow engine may further comprise explainer logic to store and make available reasoning data for at least one instance of handling an anomaly.

In another example, there may be provided a method of operating a conversational flow engine comprising: accessing a machine-learning model comprising at least one sequence of states of a conversational flow; monitoring the at least one sequence of states in operation to detect at least one anomaly; responsive to detection of the at least one anomaly, capturing data linked to a detected anomaly at an anomaly-detected state of the at least one sequence of states in operation; responsive to the capturing data, linking a tag with at least the data to the anomaly-detected state to create a tagged state; and refining the machine-learning model according to inputs obtained using the tagged state. The method may further comprise operating the anomaly detector to detect at least one of an ambiguity in an interaction, a failure to extract meaning from a response, a divergence in conversational flow topic, a missing response, an indicator of noise interference, an indicator of emotive response and an indicator of a misunderstood question-response interaction. The method may further comprise operating the anomaly detector to localise an effect of the anomaly-detected state to a phase in the operation of the conversational flow engine. The data capture logic may capture data linked to at least one of a predecessor state of the anomaly-detected state and a potential successor state of the anomaly-detected state. The refinement logic may retrain the machine-learning model. The inputs obtained using the tagged state comprising at least one of a noise adjustment algorithm output, previously-stored data associated with a user of the adaptive conversational flow engine and outputs of machine reasoning over the data linked to the detected anomaly. The method may further comprise using explainer logic to store and make available reasoning data for at least one instance of handling an anomaly.

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product tangibly embodied in a non-transitory computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1. An adaptive conversational flow engine comprising:
a machine-learning model comprising at least one sequence of states of a conversational flow;
an anomaly detector operable to monitor said at least one sequence of states in operation;
data capture logic operable in response to said anomaly detector to capture data linked to a detected anomaly at an anomaly-detected state of said at least one sequence of states in operation;
annotator logic operable in response to said data capture logic to link a tag with at least said data to said anomaly-detected state to create a tagged state; and
refinement logic to refine said machine-learning model according to inputs obtained using said tagged state.

2. The adaptive conversational flow engine of claim 1, operable to support natural-language interaction.

3. The adaptive conversational flow engine of claim 1, said anomaly detector operable to detect at least one of an ambiguity in an interaction, a failure to extract meaning from a response, a divergence in conversational flow topic, a missing response, an indicator of noise interference, an indicator of emotive response and an indicator of a misunderstood question-response interaction.

4. The adaptive conversational flow engine of claim 1, said anomaly detector further operable to localise an effect of said anomaly-detected state to a phase in the operation of the conversational flow engine.

5. The adaptive conversational flow engine of claim 1, said data capture logic further operable to capture data linked to at least one predecessor state of said anomaly-detected state.

6. The adaptive conversational flow engine of claim 1, said data capture logic further operable to capture data linked to at least one potential successor state of said anomaly-detected state.

7. The adaptive conversational flow engine of claim 1, said refinement logic operable to retrain said machine-learning model.

8. The adaptive conversational flow engine according to claim 1, said inputs obtained using said tagged state comprising a noise adjustment algorithm output.

9. The adaptive conversational flow engine according to claim 1, said inputs obtained using said tagged state comprising previously-stored data associated with a user of said adaptive conversational flow engine.

10. The adaptive conversational flow engine according to claim 1, said inputs obtained using said tagged state comprising outputs of machine reasoning over said data linked to said detected anomaly.

11. The adaptive conversational flow engine according to claim 1, further comprising a knowledge base provisioned with data derived from at least one prior instance of handling an anomaly.

12. The adaptive conversational flow engine according to claim 1, further comprising explainer logic to store and make available reasoning data for at least one instance of handling an anomaly.

13. A method of operating a conversational flow engine comprising:
accessing a machine-learning model comprising at least one sequence of states of a conversational flow;
monitoring said at least one sequence of states in operation to detect at least one anomaly;
responsive to detection of said at least one anomaly, capturing data linked to a detected anomaly at an anomaly-detected state of said at least one sequence of states in operation;
responsive to said capturing data, linking a tag with at least said data to said anomaly-detected state to create a tagged state; and
refining said machine-learning model according to inputs obtained using said tagged state.

14. The method of claim 13, further comprising operating said anomaly detector to detect at least one of an ambiguity in an interaction, a failure to extract meaning from a response, a divergence in conversational flow topic, a missing response, an indicator of noise interference, an indicator of emotive response and an indicator of a misunderstood question-response interaction.

15. The method of claim 13, further comprising operating said anomaly detector to localise an effect of said anomaly-detected state to a phase in the operation of the conversational flow engine.

16. The method of claim 13, further comprising operating said data capture logic to capture data linked to at least one of a predecessor state of said anomaly-detected state and a potential successor state of said anomaly-detected state.

17. The method of claim 13, further comprising operating said refinement logic to retrain said machine-learning model.

18. The method of claim 13, said inputs obtained using said tagged state comprising at least one of a noise adjustment algorithm output, previously-stored data associated with a user of said adaptive conversational flow engine and outputs of machine reasoning over said data linked to said detected anomaly.

19. The method of claim 13, further comprising operating explainer logic to store and make available reasoning data for at least one instance of handling an anomaly.

20. A computer program product stored on a non-transitory computer-readable storage medium and comprising computer program code to, when loaded into a computer system and executed thereon, cause said computer to:
access a machine-learning model comprising at least one sequence of states of a conversational flow;
monitor said at least one sequence of states in operation to detect at least one anomaly;
responsive to detection of said at least one anomaly, capture data linked to a detected anomaly at an anomaly-detected state of said at least one sequence of states in operation;
responsive to said capturing data, link a tag with at least said data to said anomaly-detected state to create a tagged state; and
refine said machine-learning model according to inputs obtained using said tagged state.
